(19) United States
(12) Patent Application Publication
(10) Pub. No.: US 2014/0008092 A1
(43) Pub. Date: Jan. 9, 2014

(54) HUMAN-CARRIED WORK MACHINE POWERED BY HYBRID DRIVE SYSTEM

(71) Applicant: Kenya Yanagihara, Aichi (JP)

(72) Inventor: Kenya Yanagihara, Aichi (JP)

(73) Assignee: MAKITA CORPORATION, Aichi (JP)

(21) Appl. No.: 14/007,049

(22) PCT Filed: Feb. 9, 2012
(86) PCT No.: PCT/JP2012/052934

§ 371 Date: Sep. 24, 2013

(30) Foreign Application Priority Data
Mar. 31, 2011 (JP) 2011-080892

(51) Int. Cl. B25F 5/00

(52) U.S. Cl. CPC B25F 5/00
USPC 173/213

(57) ABSTRACT

A human-carried work machine is provided with an engine and an electric motor as a prime mover for driving a tool. The engine includes an output shaft that is connected to the tool, and the electric motor is configured to apply torque to the output shaft of the engine. The electric motor is an outer rotor-type brushless motor and includes a rotor that is fixed to the output shaft of the engine and a stator core that is fixed to a crankcase of the engine. The rotor includes a peripheral wall that surrounds the stator core and a magnet is disposed on an inner surface of the peripheral wall.

### TECHNICAL FIELD

The present teachings relates to a human-carried, e.g. a hand-held or shoulder-held work machine.

### BACKGROUND ART

JP2010-84673A discloses a mower. The mower is a kind of a human-carried work machine powered by an engine, more specifically is provided with the engine as a prime mover for driving a mowing blade.

### SUMMARY OF INVENTION

### Technical Problem

There is a need for high output in a human-carried work machine to improve work efficiency. On account of this, efforts have been made to develop an engine with increased displacement. However, there are the drawbacks of requiring a long time and high cost to develop a new engine.

With the foregoing in view, the present description provides teachings which enable to increase an output of a human-carried work machine without needing the engine with increased displacement.

### Solution To Technical Problem

In the present teachings, both of an engine and an electric motor are used as a prime mover to drive a tool. With the electric motor being installed in addition to the engine in the configuration, an output of a work machine can be increased even though a size of the engine is identical to that of a conventional engine. Hence, an engine with large displacement amount is not required. Since there is no need to newly develop an engine with large displacement, a high power human-carried work machine can be realized without spending a lot of time and cost for the development.

### BRIEF DESCRIPTION OF DRAWINGS

FIG. 1 is a view showing an external appearance of a mower of an embodiment.

FIG. 2 is a view showing a rear portion of a power unit of the mower.

FIG. 3 is a sectional view taken along a line in FIG. 2, and is a view showing an inner structure of the power unit.

FIG. 4 is a block diagram showing an electric configuration of the mower of the embodiment.

### DESCRIPTION OF EMBODIMENTS

In one embodiment of the present teachings, it is preferable that an engine includes an output shaft (for example, crankshaft) connected to a tool and an electric motor is configured to apply torque to the output shaft of the engine. According to the configuration, not only a human-carried work machine can simply be designed, but also loss of the torque outputted by the electric motor can be reduced.

In one embodiment of the present teachings, it is preferable that the electric motor is fixed to the output shaft of the engine and includes a rotor that is provided with at least one magnet. In this case, it is further preferable that the rotor is provided with a cooling fan that is configured to send cooling air to the engine.

In one embodiment of the present teachings, it is preferable that the electric motor includes a stator core that is fixed to a case (including a crankcase or a cylinder block) of the engine and faces the magnet of the rotor. In this case, it is preferable that the rotor includes a peripheral wall that surrounds the stator core, and the magnet is disposed on an inner surface of the peripheral wall.

In one embodiment of the present teachings, it is preferable that the electric motor is configured to further function as an electric generator. According to the configuration, when there is an allowance in an output of the engine, electric energy can be stored. Alternatively, an increase in an energy efficiency and a reduction in a carbon dioxide emission amount can be achieved by performing regenerative braking for the tool.

In the embodiment described above, it is preferable that the human-carried work machine further includes an operable portion that is configured to be operated by a user to adjust the output of the engine. In addition, it is preferable that when an amount of operation applied to the operable portion is less than a first predetermined amount, the electric motor is configured to serve as the electric generator, and when the amount of operation applied to the operable portion is more than a second predetermined amount, the electric motor is configured to serve as the prime mover for driving the tool.

In one embodiment of the present teachings, it is preferable that the electric motor is configured to function as a “cell” motor (starter motor) for starting the engine. That is, it is preferable that the electric motor rotates the engine by applying the torque to the crankshaft when the user starts the engine (that is, when the user operates a starter switch). According to the configuration, the user can easily start the engine.

In one embodiment of the present teachings, the human-carried work machine may be any of a mower, a weeder, a chain saw, a circular cutter (cut-off saw), a sprayer, a duster, a blower, or a dust collector. In this case, the tools of the human-carried work machine include not only cutters of a moving blade, a saw chain and the like but a blowing fan and a pump. Incidentally, the human-carried work machines are not limited to the examples described above but widely include work machines which the user carries to perform operations.

In one embodiment of the present teachings, the engine for driving the tool may be either of a two stroke engine or a four stroke engine. Or, the engine may be an engine of other style (typically, internal combustion engine). The style of the engine is not particularly limited.

In one embodiment of the present teachings, the electric motor for driving the tool may be either of a motor with a brush or a brushless motor. Or, the electric motor may be an electric motor of other style (typically, direct current motor). The style of the electric motor is not particularly limited. However, in a human-carried work machine which utilizes a combustible fuel, it is preferable to adopt a brushless motor which does not need a contact type commutator.

In one embodiment of the present teachings, it is preferable that the human-carried work machine includes an electric power storage and electric power stored to the electric power storage is supplied to the electric motor. In addition, it is also preferable that in the human-carried work machine the electric power generated by the electric motor is supplied to the electric power storage to store. As one example, the electric power storage can adopt a battery pack that incorporates multiple secondary battery cells. In this case, it is further preferable that the secondary battery cell is a lithium ion cell.

In the embodiment described above, a battery pack developed for an electric power tool can be preferably employed. The battery pack developed for the electric power tool, particularly, the battery pack that includes the lithium ion cell has a large capacity, and can discharge a large current. Consequently, the engine can sufficiently be assisted by the motor and the electric power that is generated by the motor can be stored by a large amount by adopting such a battery pack. Consequently, it is preferable that the human-carried work machine includes a battery attaching portion that attachably and detachably receives the battery pack (for example, a battery pack of a slidingly attachable and detachable type) that is developed for the electric power tool.

In one embodiment of the teachings, it is preferable that the human-carried work machine performs idling stop. That is, it is preferable to automatically stop and start the engine in accordance with an operation of a throttle lever or a lock-off release switch by the user.

### Embodiment 1

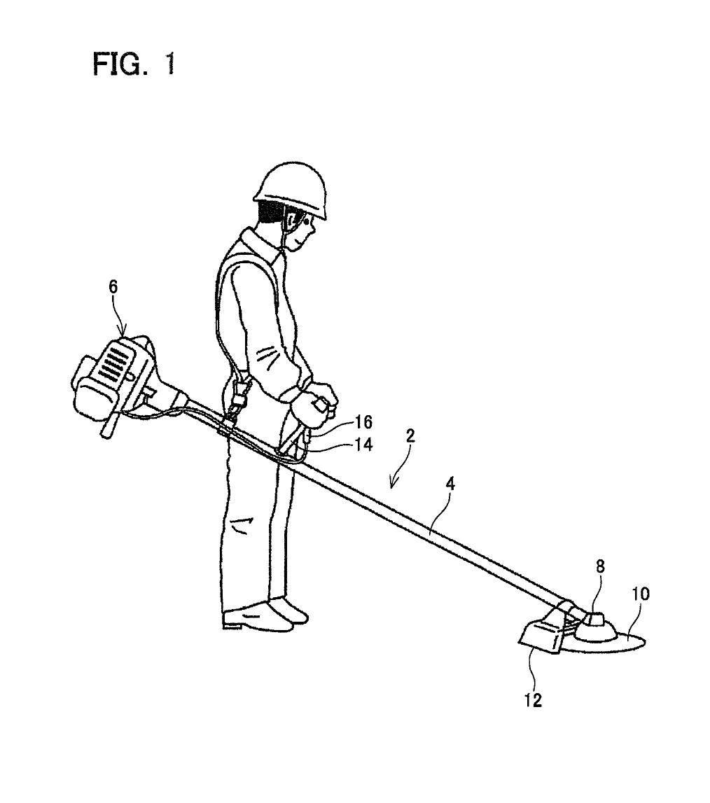

FIG. 1 shows an external appearance of a mower 2 of an embodiment. The mower 2 is an example of a human-carried work machine. The mower 2 is provided with an operation rod 4, a power unit 6 attached to a rear end portion of the operation rod 4, a gear head 8 attached to a front end portion of the operation rod 4, a mowing blade 10 in a circular disk shape attached to the gear head 8, a safety cover 12 attached to the front end portion of the operation rod 4 to cover the mowing blade 10, and a handle 14 attached to a middle portion of the operation rod 4.

The operation rod 4 is formed in a hollow pipe shape, and extended linearly. A drive shaft (not illustrated) is contained at inside of the operation rod 4. Torque outputted from the power unit 6 is transmitted to the gear head 8 via the drive shaft at inside of the operation rod 4 to rotate the mowing blade 10. The handle 14 is provided with a throttle lever 16 which performs a throttle operation of an engine 20 described later, and a stop switch (not illustrated) for stopping the engine 20. The throttle lever 16 is an operable portion operated by a user for adjusting an output of the engine.

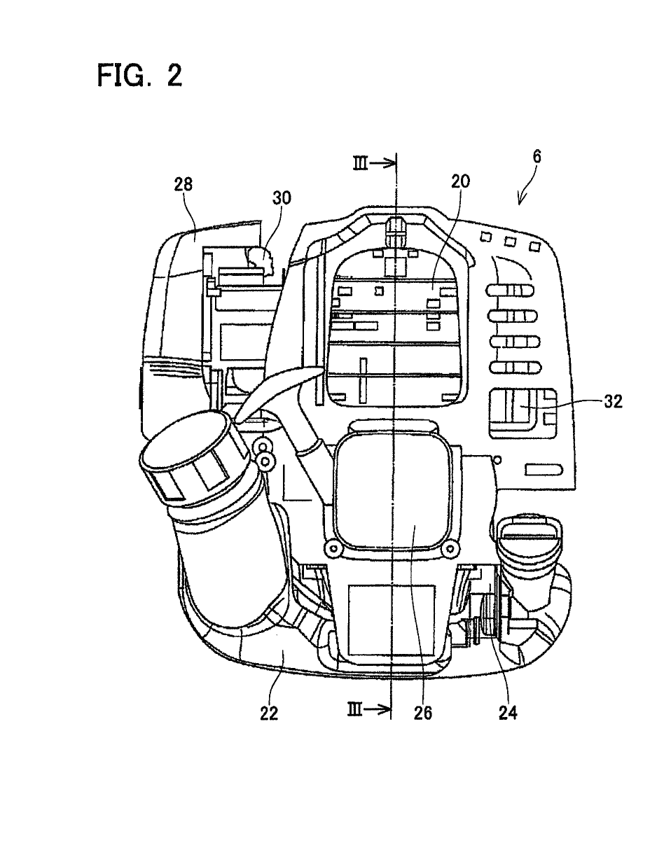

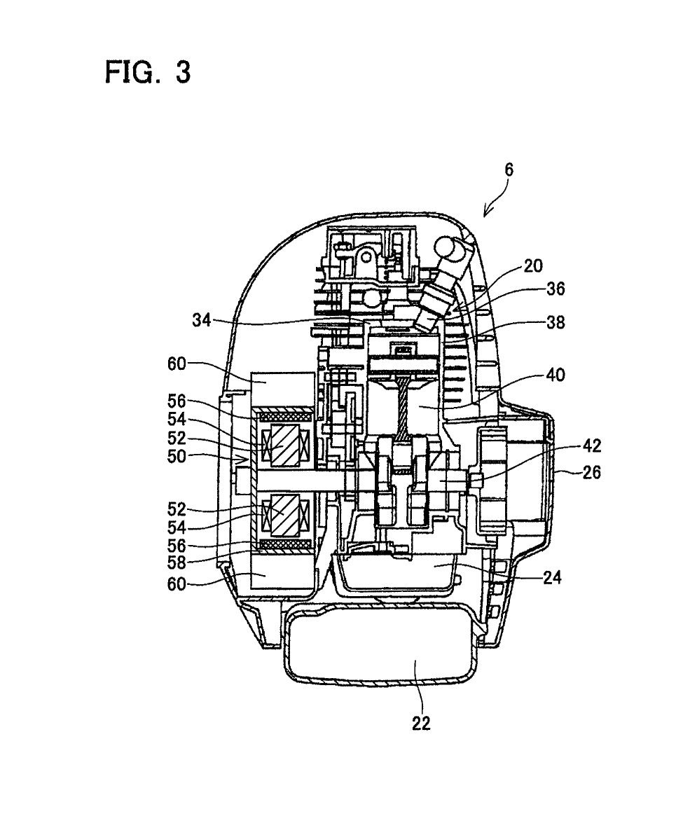

As shown in FIG. 2 and FIG. 3, the power unit 6 is provided with the engine 20, a fuel tank 22 for storing fuel of the engine 20, a recoil starter 26 for starting the engine 20, an air cleaner 28 for filtering air supplied to the engine 20, a carburetor 30 for mixing fuel to the supplied air, and a muffler 32 for discharging exhaust gas from the engine 20 to the atmosphere. The carburetor 30 is connected to the throttle lever 16, and a throttle position of the carburetor 30 is changed in accordance with an operation of the throttle lever 16.

The engine 20 is a four stroke engine of a separate oiling system. The engine 20 is provided with a cylinder 34, a piston 38 accommodated in the cylinder 34, an ignition plug 36 provided at the cylinder 34, a crankcase 40, a crankshaft 42 accommodated in the crankcase 40, and an oil pan 24. The crankshaft 42 is an output shaft of the engine 20, and connected to the drive shaft via a centrifugal clutch (not illustrated). Thereby, the output of the engine 20 is transmitted to the mowing blade 10 through the drive shaft. That is, the engine 20 is a prime mover for driving the mowing blade 10.

As shown in FIG. 3, the power unit 6 is further provided with a motor 50. The motor 50 is a brushless three phase motor of an outer rotor type. The motor 50 is provided with stator cores 52, stator coils 54, an outer rotor 58, and magnets 56. The stator core 52 is formed by a magnetic material, and is fixed to the crankcase 40. The stator coil 54 is wound around the stator core 52 and excites the stator core 52 when electricity is conducted. The outer rotor 58 is fixed to the crankshaft 42, and is rotated along with the crankshaft 42. The outer rotor 58 is formed in a cup-like shape having a peripheral wall in a circular cylinder shape and a bottom wall provided to one end of the peripheral wall, and the peripheral wall surrounds the stator core 52. The magnets 56 are fixed to an inner peripheral face of the outer rotor 58, and face the stator cores 52 disposed inside the outer rotor 58.

An output of the motor 50 is applied from the outer rotor 58 to the crankshaft 42 of the engine 20, and is transmitted to the mowing blade 10 through the drive shaft. That is, the motor 50 is a second prime mover for driving the mowing blade 10. As described above, the mower 2 of the embodiment is a human-carried work machine of a hybrid type having different kinds of the prime movers of the engine 20 and the motor 50. For example, the engine 20 of the embodiment is an engine having the displacement of 25 cc (25 milliliters), and has an output of about 700 watts. On the other hand, the motor 50 has an output of about 650 watts. Consequently, a combination of the engine 20 and the motor 50 has an output of about 1350 watts, and the value corresponds to a 4 stroke engine having the displacement of 45 cc (45 milliliters). Thus, an output equivalent to that of an engine having a large displacement can be realized by combining the engine 20 and the motor 50, while using the engine 20 having a small displacement.

In addition, the motor 50 can function also as a generator for converting rotational energy of the crankshaft 42 to electric energy. For example, when there is an allowance in the output of the engine 20, a portion of the output of the engine 20 is converted into electric power by the motor 50. The electric power generated by the motor 50 is stored to a battery pack 90 described later.

Moreover, the motor 50 can function as a “cell” motor (starter motor) for starting the engine 20. When the user operates a start switch (not illustrated), electric power is supplied from the battery pack 90 to the motor 50, and the motor 50 rotates the crankshaft 42. Thereby, the engine 20 is started.

The outer rotor 58 of the motor 50 is integrally provided with a cooling fan 60. The cooling fan 60 is provided at an outer peripheral face of the peripheral wall of the outer rotor 58. The cooling fan 60 is configured to fan the engine 20, the motor 50, and a controller unit 70 to cool. Incidentally, a position of arranging the motor 50 is a position at which a cooling fan is arranged in a conventional product. An enlargement of a size from that of the conventional product and a change in design are restrained by integrally forming the cooling fan 60 and the outer rotor 58.

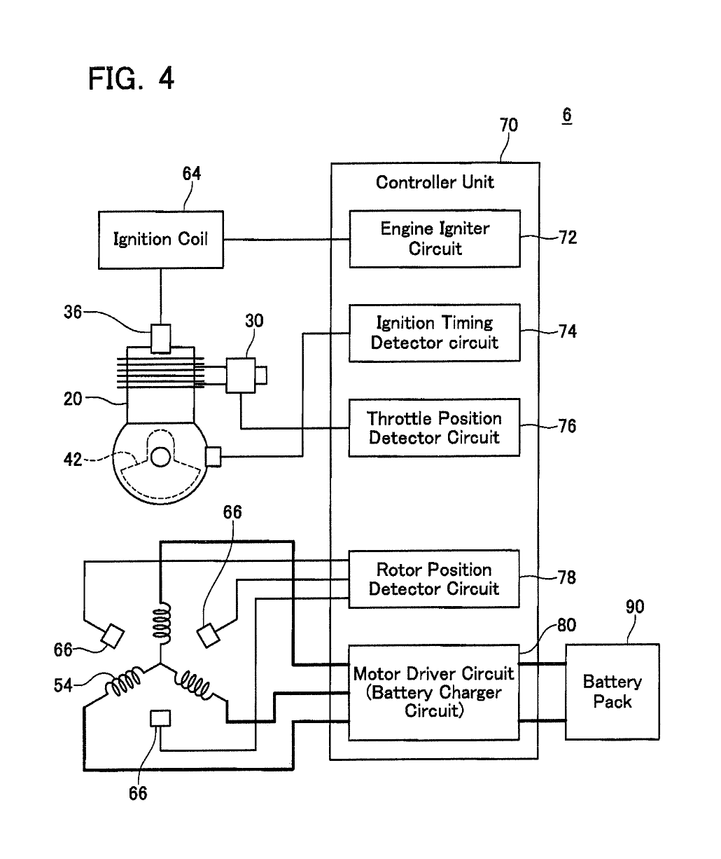

FIG. 4 is a block diagram showing an electric configuration of the power unit 6. As shown in FIG. 4, the power unit 6 is provided with the controller unit 70, and the battery pack 90 connected to the controller unit 70. The controller unit 70 is configured by multiple integrated circuits including a microcomputer. The controller unit 70 is a control portion for controlling operations of the engine 20 and the motor 50. The battery pack 90 contains multiple secondary battery cells, and supplies electric power to the motor 50 and the ignition plug 36 via the controller unit 70. The battery pack 90 of the embodiment is a battery pack containing a lithium ion cell, and having a nominal voltage of 18 volts.

The controller unit 70 is functionally provided with an engine igniter circuit 72, an ignition timing detector circuit 74, a throttle position detector circuit 76, a rotor position detector circuit 78, and a motor driver circuit 80. The engine igniter circuit 72 supplies the electric power from the battery pack 90 to the ignition plug 36. At this time, the electric power from the battery pack 90 is boosted in voltage by the ignition coil 64. An electric discharge is produced by the ignition plug 36 and an ignition to an air fuel mixture is carried out. The ignition timing detector circuit 74 determines ignition timing of the ignition plug 36 while detecting a rotational position of the crankshaft 42. The determined ignition timing is taught to the engine igniter circuit 72. The throttle position detector circuit 76 is connected to the carburetor 30, and detects a throttle position of the carburetor 30. Incidentally, the throttle position detector circuit 76 may detect an operation amount of the throttle lever 16 by the user in place of the throttle position of the carburetor 30.

The rotor position detector circuit 78 is connected to an encoder 66 of the motor 50, and detects a rotational position of the outer rotor 58. The motor driver circuit 80 is provided with multiple plural switching elements, and selectively connects respective phases of the stator coils 54 and respective electrodes of the battery pack 90 in accordance with the detected rotational position of the outer rotor 58. Moreover, the motor driver circuit 80 can perform a PWM control of the motor 50 and can control the output of the motor 50 in accordance with the detected throttle position of the carburetor 30. Also, the motor driver circuit 80 can make the motor 50 function as the generator by changing switching modes of the multiple switching elements. Thereby, the battery pack 90 can be charged. That is, the motor driver circuit 80 functions also as the battery charge circuit.

In a case where an amount of a growth of weeds to be mown is a small amount (thin), the user operates the throttle lever 16 by a small amount. In this case, the throttle position of the carburetor 30 is also small, and there is an allowance in the output of the engine 20. Consequently, the controller unit 70 makes the motor 50 function as the generator and charges the battery pack 90 by the output of the engine 20.

In a case where the amount of the growth of weeds to be mown is a middle amount, the user operates the throttle lever 16 to a middle degree. In this case, also the throttle position of the carburetor 30 is to a middle degree, and there is no excess and deficiency in the output of the engine 20. Consequently, the controller unit 70 does not make the motor 50 function also as the generator and does not make the motor 50 function also as the prime mover.

In a case where the amount of the growth of weeds to be mown is a large amount (thick), the user operates the throttle lever 16 by a large amount. In this case, the throttle position of the carburetor 30 is maximized, and the output of the engine 20 may be deficient. Consequently, the controller unit 70 makes the motor 50 function as the prime mover, and assists a deficient output of the engine 20 by the motor 50. A large amount of the growth of weeds can strongly be mown by driving the mowing blade 10 by both of the engine 20 and the motor 50.

In a case where although the throttle lever 16 is operated by a large amount, the amount of the growth of weeds to be mown is a small amount, or in a state of idling in which the mowing is not performed, a rotational frequency of the engine may be more than a predetermined value (for example, rotational frequency achieving maximum output), and at this time, it can be said that there is the allowance in the output of the engine. Consequently, when the rotational frequency of the engine is more than the predetermined value (particularly, the rotational frequency achieving the maximum output), it is preferable that the controller unit 70 makes the motor 50 function as the generator and charges the battery pack 90 by the output of the engine 20.

When the user pulls back the throttle lever 16 to an original point position, the controller unit 70 stops feeding electricity to the ignition plug 36 and stops the engine 20. This is so-called idling stop. Thereafter, when the user operates the throttle lever 16, the controller unit 70 drives the crankshaft 42 by the motor 50 and restarts the engine 20. An energy consumption amount and an exhaust gas emission amount are reduced by avoiding useless idling.

Specific embodiment of the present teachings is described above, but this merely illustrates some possibilities of the teachings and do not restrict the claims thereof. The art set forth in the claims includes variations and modifications of the specific example set forth above. The technical elements disclosed in the specification or the drawings may be utilized separately or in all types of combinations, and are not limited to the combinations set forth in the claims at the time of filing of the application. Furthermore, the art disclosed herein may be utilized to simultaneously achieve a plurality of aims or to achieve one of these aims.

1. A human-carried work machine comprising an engine and an electric motor as a prime mover for driving a tool.

2. The human-carried work machine as in claim 1, wherein
the engine comprises an output shaft that is connected to the tool, and
the electric motor is configured to apply torque to the output shaft of the engine.

3. The human-carried work machine as in claim 2, wherein the electric motor comprises a rotor that is fixed to the output shaft of the engine and is provided with at least one magnet.

4. The human-carried work machine as in claim 3, wherein the rotor is provided with a cooling fan that is configured to send cooling air to the engine.

5. The human-carried work machine as in claim 3, wherein the electric motor comprises a stator core that is fixed to a crankcase of the engine and faces the magnet of the rotor.

6. The human-carried work machine as in claim 5, wherein the rotor comprises a peripheral wall that surrounds the stator core and the magnet is disposed on an inner surface of the peripheral wall.

7. The human-carried work machine as in claim 1, wherein the electric motor is configured to further function as an electric generator.

8. The human-carried work machine as in claim 7, further comprising a battery that is configured to supply electric power to the electric motor, wherein electric power generated by the electric motor is stored in the battery.

9. The human-carried work machine as in claim 7, further comprising an operable portion that is configured to be operated by a user to adjust output of the engine,
wherein the electric motor is configured to serve as the electric generator when an amount of operation applied to the operable portion is less than a first predetermined amount, and to serve as the prime mover for driving the tool when the amount of operation applied to the operable portion is more than a second predetermined amount.

10. The human-carried work machine as in claim 7, wherein the electric motor is configured to serve as the electric generator when a rotational frequency of the engine is equal to or more than a predetermined value.

11. The human-carried work machine as in claim 1, wherein the electric motor is configured to function as a starter motor for starting the engine.

12. The human-carried work machine as in claim 1, wherein the electric motor is a brushless motor.
